(19) United States
(12) Patent Application Publication
(10) Pub. No.: US 2020/0390101 A1
(43) Pub. Date: Dec. 17, 2020

(54) MICROBICIDAL COMPOSITION

(71) Applicant: DOW GLOBAL TECHNOLOGIES LLC, Midland, MI (US)

(72) Inventor: Bei Yin, Wilmington, DE (US)

(21) Appl. No.: 16/497,086

(22) PCT Filed: Mar. 29, 2018
(86) PCT No.: PCT/US18/25082

§ 371 Date: Sep. 24, 2019

Related U.S. Application Data
(60) Provisional application No. 62/479,704, filed on Mar. 31, 2017.

(51) Int. Cl. A01N 57/20; C02F 1/50

(52) U.S. Cl. CPC A01N 57/20; C02F 2303/20; C02F 2303/04; C02F 1/50

(57) ABSTRACT

A synergistic microbicidal composition comprising a hydroxymethyl-substituted phosphorus compound and nitrate, a method for inhibiting the growth of microorganisms in an aqueous medium.

This invention relates to microbicidal compositions containing a hydroxymethyl-substituted phosphorus compound and nitrate.

A composition containing an oxidizing biocide, metabolic inhibitor, and oxygen scavenger is disclosed in U.S. Pat. No. 8,614,170. In U.S. Pat. No. 8,614,170, tetrakis(hydroxymethyl) phosphonium sulfate and nitrate are mentioned as potential options for biocide and metabolic inhibitor. However, according to Xue, tetrakis(hydroxymethyl) phosphonium sulfate and nitrate were found to be antagonistic for the inhibition of sulfide. (Xue, Yuan (Fiona). Control of Microbial Sulfide Production with Nitrate and Biocide in Oilfield-Simulating Bioreactors. Thesis. University of Calgary, 2014. N.p.: n.p., n.d. 2015. Web). Presently, a need exists for a composition which inhibits sulfide. Surprisingly, it has been found that tetrakis(hydroxymethyl) phosphonium sulfate and nitrate in fact is synergistic in the inhibition of sulfide.

The present invention is directed to a synergistic microbicidal composition comprising a hydroxymethyl-substituted phosphorus compound and nitrate.

The present invention is further directed to methods for controlling the growth or metabolic activity of microorganisms in aqueous media by adding to an aqueous medium a hydroxymethyl-substituted phosphorus compound and nitrate in the ratios described herein.

As used herein, the following terms have the designated definitions, unless the context clearly indicates otherwise. The term “tetrakis(hydroxymethyl) phosphonium sulfate” refers to “THPS”, CAS No. 55566-30-8. The term “nitrate” refers to CAS No. 14797-55-8. The term “microbicide” refers to a compound capable of inhibiting the growth or metabolic activity of or controlling the growth or metabolic activity of microorganisms; microbicides include bactericides, fungicides, viricides, archaeacides and algaecides. The term “microorganism” includes, for example, fungi (such as yeast and mold), bacteria, virus, archaea and algae. The following abbreviations are used throughout the specification: ppm=parts per million by weight (weight/weight), mL=milliliter. Unless otherwise specified, temperatures are in degrees centigrade (° C.), references to percentages are percentages by weight (wt %) and amounts and ratios are on an active ingredient basis, i.e., total weight of tetrakis(hydroxymethyl) phosphonium sulfate and nitrate.

The synergistic microbicidal composition of the present invention comprises a hydroxymethyl-substituted phosphorus compound and nitrate. The weight ratio of the hydroxymethyl-substituted phosphorus compound to nitrate is from 32:1 to 1:16. Hydroxymethyl-substituted phosphorus compounds are also generally available both in undissolved form and as aqueous solutions. Suitably, the hydroxymethyl-substituted phosphorus compound is a tetrakis(hydroxymethyl)phosphonium salt. For example, the hydroxymethyl-substituted phosphorus compound can be tetrakis(hydroxymethyl)phosphonium sulfate (THPS). THPS is available from The Dow Chemical Company as AQUCAR™ THPS 75, a 75 wt % solution in water. Other tetrakis(hydroxymethyl)phosphonium salts, such as tetrakis(hydroxymethyl)phosphonium chloride, can also be used. Alternatively, the hydroxymethyl-substituted phosphorus compound is a C₁-C₃ alkyl- and alkenyltris(hydroxymethyl)phosphonium salt or tris(hydroxymethyl)phosphine. Of course, more than one of the recited hydroxymethyl-substituted phosphorus compounds can be combined for use in the present invention; in such cases, ratios and concentrations are calculated using the total weight of all hydroxymethyl-substituted phosphorus compounds. Whether present as a single hydroxymethyl-substituted phosphorus compound or a combination of multiple hydroxymethyl-substituted phosphorus compounds the ratio of hydroxymethyl-substituted phosphorus compound to nitrate is from 32:1 to 1:16.

Preferably, the compositions is substantially free of microbicides other than hydroxymethyl-substituted phosphorus compounds, i.e., it has less than 1 wt % of microbicides other than nitrate and tetrakis(hydroxymethyl) phosphonium sulfate based on total weight of active ingredients, preferably less than 0.5 wt %, preferably less than 0.2 wt %, preferably less than 0.1 wt %. Preferably, when the nitrate and tetrakis(hydroxymethyl) phosphonium sulfate are added to an aqueous medium, the medium is substantially free of other microbicides, i.e., it has less than 1 wt % of microbicides other than the nitrate and tetrakis(hydroxymethyl) phosphonium sulfate based on total weight of active ingredients, preferably less than 0.5 wt %, preferably less than 0.2 wt %, preferably less than 0.1 wt %.

The compositions of this invention may contain other ingredients, e.g., defoamers and emulsifiers. The microbicidal compositions of the present invention can be used to inhibit the growth of microorganisms or higher forms of aquatic life (such as protozoans, invertebrates, bryozoans, dinoflagellates, crustaceans, mollusks, etc) by introducing a microbicidally effective amount of the compositions into an aqueous medium subject to microbial attack. Suitable aqueous media are found in, for example: petroleum processing fluids; fuel; oil and gas field functional fluids, such as injection fluids, hydraulic fracturing fluids, produced fluids, drilling mud, completion and workover fluids; oil and gas pipelines, separation, refining, transportation, and storage system; industrial process water; electrocoat deposition systems; cooling towers; air washers; gas scrubbers; mineral slurries; wastewater treatment; ornamental fountains; reverse osmosis filtration; ultrafiltration; ballast water; evaporative condensers; heat exchangers; pulp and paper processing fluids and additives; starch; plastics; emulsions; dispersions; paints; latices; coatings, such as varnishes; construction products, such as mastics, caulks, and sealants; construction adhesives, such as ceramic adhesives, carpet backing adhesives, and laminating adhesives; industrial or consumer adhesives; photographic chemicals; printing fluids; household products, such as bathroom and kitchen cleaners; cosmetics; toiletries; shampoos; soaps; personal care products such as wipes, lotions, sunscreen, conditioners, creams, and other leave-on applications; detergents; industrial cleaners; floor polishes; laundry rinse water; metalworking fluids; conveyor lubricants; hydraulic fluids; leather and leather products; textiles; textile products; wood and wood products, such as plywood, chipboard, flakeboard, laminated beams, oriented strandboard, hardboard, and particleboard; agriculture adjuvant preservation; nitrate preservation; medical devices; diagnostic reagent preservation; food preservation, such as plastic or paper food wrap; food, beverage, and industrial process pasteurizers; toilet bowls; recreational water; pools; and spas.

The specific amount of the microbicidal compositions of this invention necessary to inhibit or control the growth or metabolic activity of microorganisms in an application will vary. Typically, the amount of the composition of the present invention is sufficient to control the growth or metabolic activity of microorganisms if it provides from 1 to 5000 ppm (parts per million) active ingredients of the composition. It is preferred that the combination of active ingredients (i.e., nitrate and tetrakis(hydroxymethyl) phosphonium sulfate) of the composition be present in the medium to be treated in an amount of at least 10 ppm, preferably at least 100 ppm, preferably at least 200 ppm. It is preferred that the active ingredients of the composition be present in the locus in an amount of no more than 5000 ppm, preferably no more than 2000 ppm, preferably no more than 1000 ppm, preferably no more than 500 ppm, preferably no more than 300 ppm, preferably no more than 200 ppm. In a method of this invention, a composition is treated to control microbial growth or metabolic activity by adding, together or separately, nitrate and tetrakis(hydroxymethyl) phosphonium sulfate in amounts that would produce the concentrations indicated above.

### EXAMPLE

Inside an anaerobic chamber (Bactron anaerobic chamber), a deoxygenated sterile salt solution (3.12 g of NaCl, 0.13 g of NaHCO₃, 0.17 g of Na₂SO₄, 47.70 mg of KC1, 72.00 mg of CaCl₂, 54.49 mg of MgSO₄, 43.92 mg of Na₂CO₃ in 1 L water and then enriched with 5% of ATCC 1249 Modified Baar's Medium) was inoculated with a sulfate-reducing bacteria which has a high similarity in 16S rRNA gene sequence with Desulfovibrio alaskensis and Desulfovibrio vietnamensis, at a final bacterial concentrations of 10⁷ CFU/mL. The aliquots of this contaminated water were then treated with THPS, sodium nitrate, and THPS/ sodium nitrate combinations at different active concentration levels. After the mixtures were incubated at 35° C. for 2 days, sulfide level in all treatments including non THPS and or nitrate controls were measured using a colorimetric method described by D. Andrew et. al in “Standard Methods for the Examination of Water and Wastewater 4500-S2-”, with a scaled down sample size (250 μl) and reagents (scaled down accordingly) to allow the analysis to be done in 96-well micro-titer plates. Final results were read using a 96-well plate reader (TECAN Sunrise) at wavelength of 580 nm. The treatments that were able to keep the sulfide concentration under 10 ppm was considered effective (failed treatments ended up with a sulfide concentration ranging from 42 to 99 ppm). Table 1 summarizes the efficacy of THPS, nitrate and their combinations, as well as the Synergy Index* of each combination.

The test results for demonstration of synergy of the combinations are shown in the table below. The table shows the results for each single component and combinations of two components against sulfide production of the microorganisms tested with incubation times; the end-point activity in ppm measured by the level of sulfide control for compound A alone (CA), for component B alone (CB), and the mixture (Ca) and (Cb); the calculated SI value; and the range of synergistic ratios for each combination tested. SI is calculated as follows:

Ca/CA+Cb/CB=Synergy Index (“SI”)

Wherein:
Ca=Concentration of biocide A required to achieve a certain level of sulfide control when used in combination with B
CA=Concentration of biocide A required to achieve a certain level of sulfide control when used alone
Cb=Concentration of biocide B required to achieve a certain level of sulfide control when used in combination with A
CB=Concentration of biocide B required to achieve a certain level of sulfide control when used alone
   When the sum of Ca/CA and Cb/CB is greater than one, antagonism is indicated. When the sum is equal to one, additivity is indicated, and when less than one, synergism is demonstrated.

TABLE 1
Sulfide control efficacy of tetrakis(hydroxymethyl)
phosphonium sulfate (THPS) and nitrate against anaerobic
sulfate-reducing bacteria, and Synergy Index

| | Active ppm concentration | | | |
|---|---|---|---|---|
| Active weight | required to control | | | |
| ratio of | sulfide below 10 ppm | | Sulfide | Synergy |
| THPS:Nitrate | THPS | Nitrate | (ppm) | Index |
| 1:0 | 12.50 | 0.0 | 2.48 | |
| 32:1 | 6.25 | 0.20 | 7.22 | <0.50 |
| 16:1 | 6.25 | 0.39 | 3.61 | <0.50 |
| 4:1 | 6.25 | 1.56 | 7.76 | <0.50 |
| 2:1 | 6.25 | 3.13 | 8.73 | <0.50 |
| 1:1 | 6.25 | 6.25 | 2.91 | <0.51 |
| 1:2 | 6.25 | 12.50 | 4.62 | <0.52 |
| 1:4 | 6.25 | 25.00 | 6.73 | <0.53 |
| 1:8 | 6.25 | 50.00 | 7.53 | <0.56 |
| 1:16 | 6.25 | 100.00 | 3.79 | <0.63 |
| 0:1 | 0.0 | >800 | 74.26 | |

* Treatment of THPS alone at 6.25 ppm resulted in 42.15 ppm of sulfide

1. A synergistic microbicidal composition comprising a hydroxymethyl-substituted phosphorus compound and nitrate.

2. The synergistic microbicidal composition of claim 1 wherein the ratio of hydroxymethyl-substituted phosphorus compound to nitrate is 32:1 to 1:16.

3. The synergistic microbiocidal composition of claim 1 wherein the hydroxymethyl substituted phosphorus compound is tetrakis(hydroxymethyl) phosphonium sulfate.

4. The synergistic microbicidal composition of claim 3 wherein the ratio of tetrakis(hydroxymethyl) phosphonium sulfate to nitrate is 32:1 to 1:16.

5. A method for controlling the growth of microorganisms in an aqueous medium; the method comprising adding to the aqueous medium the synergistic microbiocidal composition of claim 1.
